(19) United States
(12) Patent Application Publication
(10) Pub. No.: US 2007/0061224 A1
(43) Pub. Date: Mar. 15, 2007

(54) Method and system for ordering and performing printing services and postal services

(76) Inventors: Juergen Hofmann, Koeln (DE); Joachim Rick, Koenigswinter (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/559,488

(22) PCT Filed: Apr. 29, 2004
(86) PCT No.: PCT/DE04/00893

§ 371 Date: Oct. 16, 2006

(30) Foreign Application Priority Data
May 28, 2003 (DE) 103 24 539.1

(51) Int. Cl. G06Q 30/00

(52) U.S. Cl. 705/27

(57) ABSTRACT

The invention relates to a method for ordering and performing printing services and mailing services in a system in which a user can generate an order for an individual piece of mail that is to be sent on an order component of the system in a way that involves little effort on the part of the user, and the user has a great deal of freedom in selecting the design of the mail.

### BACKGROUND OF THE INVENTION

1. Field of the Invention

The invention relates to a method for the automated ordering and performing of printing services and mailing services in a mailing service system, with which the order data for mail to be printed and sent is generated on an order component.

The invention also relates to a system for carrying out a method for the automated ordering and performing of printing services and mailing services in a mailing service system.

2. Description of Related Technology

In known systems for printing services in combination with mailing services (mailing service systems), so-called hybrid mail services are becoming more and more widespread. Providers of such services allow the users of an associated system to submit electronic data for postal products such as letters, postcards, mailings, etc., after which this data is edited and optionally provided with other added-value services converted into the physical final products. Afterwards, the addressed products are forwarded to a logistics process for purposes of distribution.

The addressed mail can be, for example, either classic types of letters or postcards or else electronic messages in the form of e-mails. Such mailings are used in large volumes especially for advertising and/or information campaigns. For example, comprehensive mailing campaigns are used to publicize new companies to certain segments of the population and to mail out information brochures or catalogs. Moreover, for certain occasions such as special sales and events, information mailings are sent out in large volumes. Mailing campaigns of various types are also suitable for sending cards for holidays, for example, at Christmas time.

Typically, however, utilization of the service is associated with many restrictions and obstacles for users of a hybrid mailing system. For example, minimum batch sizes are required since otherwise the production is not cost-effective for the provider of the service. Moreover, invoicing for the individual services is not cost-effective for the service providers if they do not require certain minimum batch sizes. Furthermore, normally speaking, a special auxiliary means for the user is needed for generating the electronic data. This is often special software that has to be installed in the customer's environment in order to edit the customer data in such a way that it can be prepared for a printing order submitted to the provider. It is also a known procedure to use converters at the provider's facilities in order to be able to edit transmitted customer data so as to prepare it for production.

However, the generation of an order for printing and mailing an individual piece of mail whose design can be selected by the user is not possible with such systems. Therefore, there is a need for a method and a system that allow a user to commission a service system provider, for example, with the personalized printing of an individual postcard and the subsequent sending of the postcard.

U.S. Pat. No. 5,805,810 discloses, for example, a method for generating mailpieces from e-mail messages. The method provides that an e-mail message is sent in a computer system including at least one database with an identification of the sender and of the appertaining recipient as well as a message checking unit. The database includes address information of senders and recipients. When an electronic message is sent to the checking unit, it accesses the database entry pertaining to the sender in a sender database and determines the sender's address from this. Moreover, the unit checks whether the ascertained sender has sufficient credit in an account for sending a mailpiece. Then, on the basis of the recipient identification, the delivery address of the registered recipient is ascertained in the recipient database. A printing component generates a print-out from the text of the e-mail and provides this mailpiece with the sender and recipient addresses.

Moreover, U.S. Pat. Appln. No. 2002/0132609 A1 discloses a scalable system for transmitting messages that is configured as a wireless network. Wireless equipment such as PDA's, mobile telephones, or laptops can send and retrieve messages.

### GENERAL DESCRIPTION OF THE INVENTION

The invention provides a method for ordering and performing printing services and mailing services in a system in which a user can generate an order for an individual piece of mail that is to be sent on an order component of the system in a way that involves little effort on his part, whereby the user has a great deal of freedom in selecting the design of the mail. The method should also make it possible for sponsors to subscribe flexibly to the mailing service system in order to, for example, carry out advertising campaigns.

The invention provides a system for carrying out such a method for ordering and performing individual printing services and mailing services.

This objective is achieved according to the invention by a method for the automated ordering and performing of printing services and mailing services in a mailing service system, with which the order data for mail to be printed and sent is generated on an order component, whereby the method is characterized by the following steps:

generation of order data by means of an order component, whereby the order data consists of at least one image motif and of delivery information,

transmission of the order data to a database via an interface,

editing of the order data into a printing order in an editing component that is connected to the database,

transmission of the printing order to a printing production component,

generation of mail in the printing production component,

transfer of the mail to a distribution system, and

invoicing for the printing service and the mailing service via an invoicing component.

In an especially preferred embodiment of the invention, the mail to be printed and sent is a postcard that typically includes an image motif side and a text side with a greeting text, optionally with advertising and with delivery information. Other cards such as, for instance, greeting cards or folding cards can also be produced. The order component employed can be one of several means. It is advantageous, for example, to generate an order for mail to be printed and sent via applications of a website connected to an associated server. A website or webpage is defined as an HTML file published on the World Wide Web. The website and the server can belong to a fixed mailing service system or to sponsors who can subscribe flexibly to the mailing service system. The term “sponsors” in this context refers to users of the mailing service system who make it possible for other users to produce and send mail, whereby the costs for the services performed are partially or completely paid for by the sponsor. These sponsors preferably sign up with the mailing service system, as a result of which so-called sponsored events are produced having certain properties such as the duration or the number of sponsored pieces of mail.

A fixed mailing service system for ordering and performing printing services and mailing services can be operated, for example, by a postal service provider and can have various components for the automation of the procedures. In addition to an order component in the form of a website and an associated server, it is advantageous to have at least one database, an editing component connected to this database for editing data into printing orders and suitable interfaces for transmitting the data. It is also necessary to have a printing production component for producing mail and an invoicing component for invoicing for printing services and mailing services that have been performed. These components can be permanently integrated into the mailing service system or, as is advantageous, for example, for the printing production component, they can be segregated from the system. Thus, various printing service providers can be connected to the mailing service system of a postal service provider, as a result of which a high modularity and thus a great flexibility are achieved. The possibility to printing orders with a batch size of one has to do especially with the presence of an appropriate printing production component that is capable of consolidating the orders into larger orders.

In an especially preferred embodiment of the invention, an invoicing component invoices the user for all or part of the costs incurred for the order he has generated for the printing service and the mailing service for the mail to be sent via the mailing service system. This variant corresponds to the usual modality of payment for a service that has been utilized by a user who has placed an order. However, it has proven to be advantageous to also allow other invoicing variants. For example, it can be advantageous for user groups of a system to offer their customers the possibility to send mail free of charge or at a reduced rate as an advertising campaign. With such a sponsoring approach, a customer can, for instance, select a postcard and send it, whereby the costs incurred are partially or completely charged to the sponsor in question. The invoicing component then completely or partially invoices a user (sponsor) who did not generate the order for the printing service and the mailing service. In an especially preferred embodiment of the invention, the invoicing for the services is carried out before the mail is printed and sent out.

In addition to producing orders for mail to be printed and sent via a website connected to an associated server, it has also proven to be advantageous that a user can generate an order by means of a mobile terminal and that the data for an order is transmitted to an interface of the mailing service system. In order to provide data that this interface can process, it can be practical for the data transmitted by the mobile terminal to be converted, for example, in a second interface located in-between, into a format that can be processed by the mailing service system or by the database and the associated interface.

The generation of an order for mail such as a postcard comprises at least the provision of delivery information and the selection of a motif for the postcard to be printed. Moreover, the user typically supplies a greeting text. In this context, the postcard motif can be selected by the user from a given collection or generated and provided by the user himself. Selectable motifs can be predefined, for example, by the mailing service system or by a sponsor. Here, it is especially advantageous for the sponsor that he can integrate the desired properties, such as advertising slogans, into the motifs. Especially in an embodiment in which an order is generated on a mobile terminal such as a mobile telephone, it is advantageous for a user that he can produce current images or photographs with a function of the mobile telephone and can then send these in the form of a postcard.

If a user generates an order for mail to be printed and sent via a website connected to an associated server, then a number of sub-variants are possible, especially if sponsors are involved. The selection of the image motifs and the generation of the orders can be carried out completely on the website of the mailing service system or completely on the website of a sponsor so that the sponsor merely transmits the orders to the mailing service system.

The descriptions of the payment for services by a sponsor are especially preferred, but the invention is not limited to application cases in which a sponsor is involved. The invention allows a flexible invoicing for services so that the function of the sponsor can, of course, also be assumed by other sponsors of services. The invention utilizes a simple capability for invoicing for mailing services and is thus not restricted to individual application cases for payment of the invoices.

The invoices can be paid, for example, by transmitting a subscriber identification number and by making a comparison with a database containing the subscriber identification number and by withdrawing a monetary amount from a user account assigned to that number.

In this embodiment of the method, of the system and of the devices for carrying out the invention, the subscriber thus identified is the sponsor 60. However, it is likewise possible for the function of the sponsor 60 to be assumed by another sponsor.

The invention also comprehends a system for carrying out a method for the automated ordering and performing of printing services and mailing services in which an order for mail to be printed and sent can be generated on an order component.

In an especially preferred embodiment of the invention, the system includes at least the following components:

an order component for generating order data, whereby the data consists of at least one image motif and of delivery information,

means for transmitting the order data from an order component to a database via an interface,

an editing component connected to the database for producing printing orders from the order data,

a printing production component connected to the database for generating the mail,

an invoicing component connected to the database for purposes of invoicing for the printing service and the mailing service.

### BRIEF DESCRIPTION OF THE DRAWINGS

Additional advantages, special features and practical embodiments of the invention will be apparent from the description below of preferred embodiments of the invention, making reference to drawings.

The drawings show the following:

FIG. 1 a depiction of an especially preferred embodiment of the mailing service system according to the invention;

FIG. 2 a depiction of the two printed sides of a postcard generated with the method and system according to the invention; and

FIG. 3 the process sequence during the generation of an order for a postcard via applications of a website.

### DETAILED DESCRIPTION

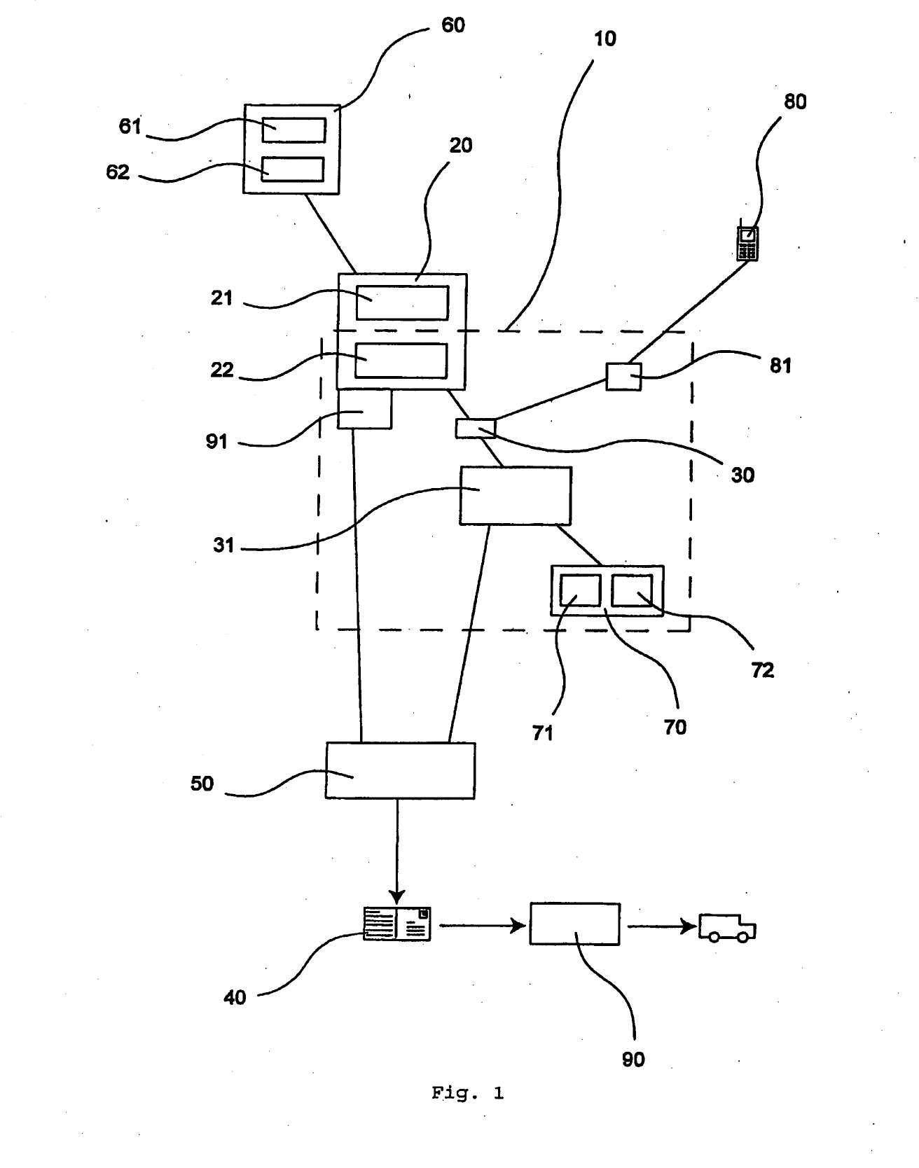

FIG. 1 shows an especially preferred embodiment of the system according to the invention for ordering printing services and mailing services. In FIG. 1, a system 10 is delineated vis-à-vis other components by a broken line in order to illustrate which components are advantageous for the operation of such a system. However, various components can be omitted or additionally integrated. The system is referred to below as “the mailing service system.” The core element of the mailing service system 10 is made up of a database 31 that serves for data storage and data retrieval and that is connected to various components of the system. The entire data management is preferably implemented in a relational database. An Oracle database, for example, has proven to be advantageous as the database. The database is connected via an interface 30 to at least one order component on which an order for mail to be printed and sent can be generated. The database is also connected to an editing component 70 for generating printing orders and to a printing production component 50 to which the generated printing orders are transmitted in order to produce the mail. It has proven to be advantageous to use a JDBC interface (Java Data Base Connectivity interface) as the interface 30. The system also comprises an invoicing component 91 for invoicing the printing service and the mailing service performed by the system.

An order component 20 is a website 21 with an associated system-side server 22. Via applications of this website 21, a user can, for example, generate an order for a postcard to be sent, whereupon the order is transmitted via the interface 30 to the database 31 and to the components that are connected to it. The order component can also be a mobile terminal of the type shown by way of an example in FIG. 1 as a mobile telephone 80. For the invention, it is advantageous that the user of the mailing service system 10 can also use such a mobile terminal to generate orders for printing services and mailing services. Here, postcard motifs can be offered to the user for selection via the mobile telephone. However, it is especially advantageous if the user can select digital images generated by the mobile telephone as image motifs for a postcard.

If a user generates an order via a mobile terminal 80, then this order is likewise transmitted via the interface 30 to the database 31. For the conversion of data and/or for additional applications, a second interface 81 can be provided between the interface 30 and the mobile terminal 80. This second interface 81 serves, for example, to convert the data format and/or to check the address.

The editing component 70 includes at least two components that are referred to here as back-end services 71 and 72. One of these components serves to generate the image motif whereas the other component generates preview data and printing data. The database is connected to at least one printing production component 50 to which the printing orders generated by the back-end services are transmitted. The printing production component can be a fixed component of the mailing service system or can be connected to the system modularly. This can be, for example, one or more printing service providers that print mail on behalf of the system. The printing production component generates mail 40 on the basis of the received data and then transfers the mail to a distribution system 90. The distribution system can include various sorting and distribution means for delivering mail to a recipient on the basis of the delivery information provided by the user. In a preferred embodiment of the invention, a connection exists between the printing production component 50 and an invoicing component 91, so that a message about a printing and/or sending job that has been carried out can be sent to this invoicing component.

In an especially preferred embodiment, the system 10 includes at least another user of the system who will be referred to below as the sponsor 60. The sponsor is flexibly associated with the system and preferably has a website 61 with applications and an associated server 62.

With the method according to the invention, the order component is used to generate an order for a printing service in conjunction with a mailing service. This is preferably an order for sending a postcard. For this purpose, a user selects an image motif for printing the postcard and provides delivery information for sending the card. The image motif can be selected in different ways. For one thing, the system offers the user a selection of image motifs among which he can choose. On the other hand, it can be advantageous that the user can generate his own image motif and can transmit it to the system 10 together with delivery information.

In an especially preferred embodiment of the invention, the depicted order component 20 is a website 21 connected to an associated server 22 that the user calls, for example, on a computer. The connection between the user and the website 21 and thus with the server 22 is preferably established via the Internet. The user generates orders for printing services and mailing services via a mobile terminal 80, which preferably reach the system as MMS messages (Multimedia Messaging Service) via smtp or http.

In an especially preferred embodiment of the invention, the orders for printing services and mailing services are orders for which low or no costs are incurred by the user. The costs are assumed by a sponsor 60. For example, it can be advantageous for a sponsor to make this sponsored service available to other users of the system for advertising purposes. Users can then visit a website by means of which they can send postcards free of charge or at a reduced rate. The website can be the website 21 of the mailing service system or the website 61 of the sponsor. Moreover, sub-variants are also possible in which, for example, the sponsor makes special card motifs available, but the user pays the card price.

If a sponsor 60 wants to provide sponsored card motifs via a payment route in which a user can generate an order but the costs for carrying out the order are charged to the sponsor, then he signs up with the mailing service system for a sponsorship campaign, referred to as a sponsored event below. Sponsored events are sponsorship campaigns with certain attributes such as, for example, a beginning date and an ending date as well as maximum upper limits. Maximum upper limits can be augmented in that periods are defined for which these upper limits are valid. For example, an upper limit could be defined as “500 cards per day” or as a global upper limit “1000 cards over the total period of time”. The sponsored events are preferably stored in table form in the database 31 of the system. A sponsored event is always associated with precisely one product and precisely one sponsor. A sponsor can have any desired number of sponsored events.

The database 31 assumes at least the following tasks within the system 10:

central provision of data logics and

central data management.

All of the applications of the system advantageously manage their data via this database. The term “application” normally refers to any user programs or comprehensive software packages such as, for example, database applications. The database 31 manages central objects such as sponsors, event status and motifs in addition to other objects. Moreover, all parameterization and control data of the applications as well as at times even the application itself can be managed via the database. The tables employed do not serve exclusively to define and configure the sponsored events, but rather, applications also actively write into this table. For example, the number of orders already sent or the computed monetary amounts can be increased in order to deactivate the event when the specified upper limits have been reached.

In an especially preferred embodiment of the invention, a table for sponsored events contains at least the following entries:

| | | ZERO | |
|---|---|---|---|
| Column | Type | allowed | Meaning |
| SP_EVENT_ID | NUMBER(15) | no | Unambiguous designation |
| | | | for the sponsored event |
| EVENT_NAME | VARCHAR2(50) | no | Name of the sponsored |
| | | | event (informative) |
| ACTIVE_FLAG | CHAR(1) | no | Event active or |
| | | | de-active?, either, ‘Y’ or |
| PERIOD_REQUESTS | NUMBER(10) | | Number of orders already |
| | | | generated in the current period |
| PERIOD_AMOUNT_EURO | NUMBER(24, 15) | | Monetary amount already |
| | | | accumulated during current period |
| BEGIN_DATE | DATE | no | Beginning date of the sponsored event |
| END_DATE | | | Ending date of the sponsored event |
| MAX_GLOBAL_REQUESTS | NUMBER(24, 15) | | Maximum global upper limit in |
| | | | orders (requests) |
| MAX_GLOBAL_AMOUNT_EURO | NUMBER(10) | | Maximum global upper limit in |
| | | | monetary amounts |
| PERIOD | NUMBER(10) | | Duration of period in days |
| PERIOD_NO | NUMBER(10) | | Current period |
| MAX_PERIOD_REQUESTS | NUMBER(10) | | Maximum period upper limit in |
| | | | orders (requests) |
| MAX_PERIOD_AMOUNT | NUMBER(24, 15) | | Maximum period upper limit in |
| | | | monetary amounts (requests) |
| GLOBAL_REQUESTS | NUMBER(10) | no | Total number of orders already generated |
| GLOBAL_AMOUNT_EURO | NUMBER(24, 15) | no | Total number of monetary amount |
| | | | already accumulated |
| COMPANY_ID | NUMBER(20) | no | Identification (COMPANY_ID) |
| | | | of the sponsor |

A standard API (Application Programming Interface) has proven to be especially advantageous for accessing such a table, said interface having functions such as insert, modify, delete and search. Moreover, it is advantageous for the API to contain a function that determines whether a sponsored event is active, inactive or temporarily inactive, or else that sets this status when upper limits or the beginning or end of time periods have been reached.

The number of sent pieces of mail as well as the already booked monetary amounts pertaining to a sponsored event can be counted by a trigger. A trigger increases the number of sent pieces of mail or else the amount pertaining to an event and subsequently checks whether the upper limits have been reached yet or not. Once a maximum upper limit has been reached, the event is deactivated.

Various embodiments are possible for sponsored events. For all of the variants, the sponsor 60 has to provide the mailing service system 10 with the desired card motifs. Here, the system can set certain requirements, if applicable. It has proven to be advantageous to prescribe the transmitted data format, the file size, the color selection, the resolution and/or the final sizes. For example, the card motif can be required as a TIFF file, in CMYK colors, with a resolution of at least 350 dpi (pixels/inch) and a final size of 15.25 cm×10.90 cm (actual postcard format of 14.85 cm×10.5 cm+cutting waste). It can be necessary for the system 10 to edit the image motif so as to prepare it for printing and to import it into the system's own database. Raw data is imported, for example, into the system 10 whereas fine data is imported into the printing production component 50.

In a first embodiment, a user generates an order for mail to be printed and sent in that he enters the website 21 of the system 10. Sponsored and non-sponsored image motifs can be offered on this website. The sponsored image motifs, like the non-sponsored image motifs for which there will be a charge, are shown in the motif selection. With the sponsored image motif, a reference to the sponsor can be made in the form of a text or a logo for advertising purposes. The user selects an image motif and, together with delivery information, generates the order that is transmitted to the database 31 and to the components connected to it.

This embodiment involves the least effort for the sponsor 60. He merely has to provide the system 10 with the image motif. The user can either enter the website 21 directly or else the sponsor creates a link to the website of the system on his own website 61 and on the associated server 62. This embodiment, however, does not allow any further-reaching integration of the sponsor into the system 10. Moreover, any user of the website of the system can see the sponsored image motifs and can send them free of charge. Hence, a restriction to users who have previously visited the website of the sponsor is not possible.

In a second embodiment, a user selects the image motif of the desired postcard on the website 61 of the sponsor and sends the postcard via the system 10. The internal motif selection of the system 10 is not accessible to the user in this case. This variant ensures that the user has to have visited the website of the sponsor in order to be able to send a free postcard. The user is automatically redirected by appropriate links on a website of a sponsor to applications on a website of the mailing service system. The user employs these applications to generate an order for mail to be printed and sent, and the server of the mailing service system transmits the data for an order to the database. This form entails a bit more effort on the part of the sponsor. This is mainly due to the need to ensure that the user of the system 10 truly accesses the system 10 from the website of the sponsor. The automatic redirecting of the user from the website of the sponsor to the website of the mailing service system is preferably carried out via a reciprocal communication process between the server of the sponsor and the server of the mailing service system. In order to ensure that a user of the system 10 has come from the website of a sponsor 60, the following method has proven to be especially advantageous:

The sponsor 60 loads a special page of the website 21 via HTTPS (Hypertext Transfer Protocol, secure). This can be done, for example, via an ASP, CGI or JSP program. The abbreviation ASP stands for “Active Server Pages”. These are active Internet pages. These pages can contain, for example, scripts that are executed on a server before they appear in the browser. The designation CGI stands for “Common Gateway Interface” and is a data exchange interface between a web server and a client that is capable of receiving CGI-compliant data and if applicable, of further processing said data and sending it back to the server. The abbreviation JSP stands for “Java Server Pages”. JSP pages are HTML files with specifically marked embedded java programs.

The special page of the website 21 is protected in order to prevent third parties from sending cards at the expense of the sponsor. First of all, the server 62 of the sponsor 60 has to identify himself vis-à-vis the system 10 by entering an unambiguous key for the sponsored event in question. This identification (ID) is provided ahead of time by the system. Secondly, an ACL (Access Control List) ensures that only authorized IP addresses of various sponsors can gain access. Only computers of a network cited in this list are allowed to access certain services of the network. The sponsor in question has to provide his IP address ahead of time. The system 10 then clears it. Even higher security can be achieved by using client certificates.

In response to the call, the system responds with a session ID. This session ID is the key for the user to send a free postcard. The program on the web server 62 of the sponsor 60 evaluates the response and redirects the user to the website 21 of the system. This can advantageously be done via a link or redirect. Filling in and sending a desired postcard is done via various pages of the website of the system 10 as already described. If the verification reveals that a user did not access the website of the mailing service system via the website of the sponsor, then no order can be generated. The main effort involved with this embodiment lies in the implementation of the protocol for the requests for a session ID.

In another embodiment of the invention, the pages of the mailing service system 10 that are needed to fill in and send the card can be adapted individually to the website 61 of a sponsor 60 and can be visually integrated into the website of the sponsor. Here, too, first of all, a session ID is requested and the user is subsequently redirected to the website 20 of the system 10. The postcards are still filled in and sent via the system 10, but the design of the surface can be changed almost entirely at will. Instead of the individual default pages of the system, individually adapted pages of the sponsor are displayed. Except for the sequence of the pages and the parameters to be transferred on the individual pages, the design of the pages is subject to almost no restrictions.

This complete integration into the website of the sponsor entails the most effort. Various HTML pages have to be generated, checked and integrated into the system. For this purpose, the pages have to be transferred to the system 10. There they are preferably tested and integrated.

If the sponsor wants, for example, to use his own editors or to generate cards automatically, then, in another embodiment of the invention, he can also submit the orders directly on the server side without any user interaction. The. sponsor 60 does not make use of the pages of the system 10 but rather generates the necessary data himself and then submits this data on the server side to the server 22 of the system 10, which then accepts the data and books the cards. The order for mail to be printed and sent is thus generated on the website of a sponsor and the associated server transmits the data for the order directly to the server of the mailing service system that transmits the data to the database.

The compilation of the postcard data and the submission of the data to the system can also take place in a completely asynchronous manner. The sponsor 60 can, for example, collect the card data in a database and submit it to the system once per day.

If a sponsor is making use of the direct submission modality, he does not need a session ID but rather can make a direct submission in one single call. In this process, in addition to the card data, he also transfers a sponsor key with which he is identified in the mailing service system 10 and with which the sponsored event to be used can be ascertained. For reasons of downward compatibility, it has proven to be advantageous that, with this direct submission modality, instead of a sponsor key, a sponsored session ID that was previously requested is also accepted. The access to the direct submission modality is preferably likewise protected by web server ACL's in order to prevent the unauthorized sending of cards at the expense of the sponsor. Even greater security can be achieved through the use of client certificates. Moreover, it has proven to be advantageous to provide the caller with a method with which he can check whether his order has been properly accepted.

In another embodiment of the invention, the sponsor does not provide a selection of his own image motifs that a user can send free of charge or at a reduced rate but rather, the user can generate his own image motif and send it at the expense of the sponsor.

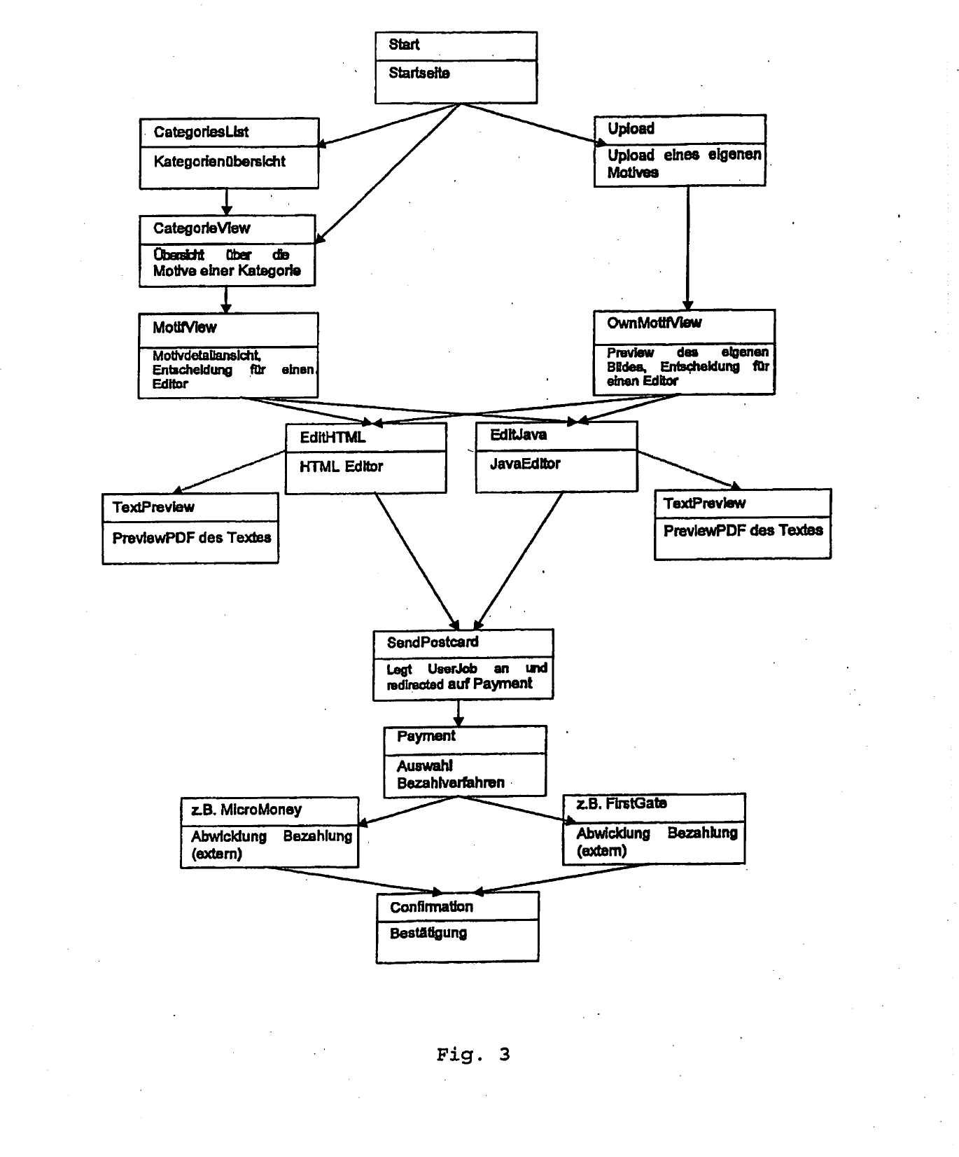

By way of an example, FIG. 3 shows the process sequence for the generation of an order for a postcard to be printed and sent via applications of a website. The process starts on a beginning page for which a layout has been produced. The layout for the beginning page and other pages can be defined by the mailing service system 10 or, for example, freely designed by a sponsor. When the website 21 of the mailing service system is called via a sponsor, then it is not the standard pages of the mailing service system that are displayed but rather the pages generated by the sponsor.

On the beginning page, a list containing the names of all of the active categories of image motifs is shown in a prescribed sorted arrangement. When the user moves the mouse pointer over a category, the zoom image of this category is displayed to the left of the category list (CategoriesList). Initially, the zoom image of the first category in accordance with the sorting is preferably displayed. When the user clicks on a category from the list, an overview page for the category is opened. On the beginning page, there can also be a link that directs the user to the branch of the application in which he can upload his own image motif. The page that then appears is designated in FIG. 3 with “upload”. This is where a motif API for reading out the category information has proven to be advantageous.

The page “CategoriesList” shows a list of the preview images of all of the active categories. When a user clicks on a preview image, he gets to the image motif overview of the selected category (CategoryView). These is where a motif API for reading out the category information has likewise proven to be advantageous.

The page with the motif list “CategoryView” shows the preview images of all of the active image motifs in the selected category. When the user clicks on a motif, he gets to the page “MotifView”. On this page, the zoom image of the motif is shown in order to provide the detailed motif view. Already before the later payment procedure, price information for a selected image motif can be displayed on this page ahead of time. This can only be information about the non-postage constituents since the user only decides on later pages where he will send his card and consequently, the postage information is not yet available at this time. A motif API has proven to be advantageous for reading out the category and image information while a pricing API has proven to be advantageous for determining and displaying the price.

If the user has decided to use his own image motif, he uploads his motif on the “upload” page. For example, he can determine the file to be used via a “browse” button. A “continue” button initiates the upload and sends the data to “OwnMotif Preview”, which accepts the data and generates and delivers the preview image.

OwnMotifPreview accepts the image data and checks it to make sure that the file is not larger than a maximum permissible upper limit. If the file provided is larger than a configured upper limit (MaxDenySize), attempted fraud can be assumed. The upload is interrupted and advantageously an error message is returned.

If the data was accepted and no error detected, then the application carries out a preliminary check of the image. Here, it is checked whether:

the image has a valid JPG header,

the file name ends in .jpg or .jpeg (case-sensitive)

the dpi number is not higher than the maximum permissible number (upper limit preferably configurable, default is, for instance, 300)

the file size is not larger than the maximum permissible size (upper limit preferably configurable, default is, for instance, 300 KB)

If the file does not meet the requirements, an error page can be displayed. If the file is correct, a MOTIF_BUILDER task is initiated and the file is stored as a Task_File. The task generates a preview image from the JPG of the user showing how the image will be positioned on the postcard and showing the print PDF. The application queries the status of the task in configurable intervals (polling). If the result is within a configurable period of time, the preview page is delivered with the preview image. In the case of images that do not fill the postcard format, the preview image has a white frame and is displayed with a frame that is 1 point wide in order to illustrate the positioning for images that do not fill the postcard format. If the task result is not present, or if an error has occurred, an error page is displayed.

On the preview page (OwnMotifPreview), links to an HTML editor (EditHTML) and a Java editor (EditJava) are offered to the user.

On the page “EditHTML,” the user enters his postcard text, the address data and (optionally) his e-mail address via an HTML form. The buttons “back”, “preview” and “continue” are offered. “Back” takes the user back to “MotifView” or “OwnMotifView”, depending on whether he is using his own motif or a standard motif.

“Preview” offers the user the optional possibility of a preview PDF. This is opened in a separate window (TextPeview). “Continue” stores the data of the user and sends it to SendPostcard, which creates a UserJob.

With “preview” and “continue,” the user entries are preferably first pre-checked on the client side with JavaScript. Here, it is checked, for example, whether a given e-mail address is RFC-compliant and whether address data was entered. With “continue”, it is also checked whether the General Terms and Conditions have been accepted. If Germany was selected as the country, it is checked whether the postal code, city and at least two additional address fields have been filled in and whether the postal code, for example, for Germany, has five digits and is numerical. If an error was found, the user is alerted to the error by means of an alert box. Once the checking of all of the items has been successful, the data is sent to a special (server-side) interaction page.

With “preview,” the interaction page creates a task that generates print PDF and preview PDF. The application queries the status of the task in configurable intervals (polling). If the result is not within a configurable period of time, or if an error has occurred, an error page is displayed. If the task was successful, the preview PDF is opened in a separate window (TextPreview).

With “continue,” the interaction page checks whether current preview PDFs and print PDFs are present that the user might already have generated via “preview”. If current PDFs are present, then these are used; the task does not have to be called once again. If no PDFs are present or if the user has changed his card data in comparison to the data used for generating the PDF, then a task is created that generates the PDFs anew. Subsequently, the data is called at SendPostcard which creates the UserJob.

On the page “EditJava,” the user enters the card text and the address data via a Java applet. In addition, the reference to the General Terms and Conditions is incorporated into the applet. The applet sends the card text data in a special XML format to the server 22. The advantage of the applet is that the user can be offered a WYSIWYG functionality (“What You See Is What You Get”) for the data input.

The buttons “back,” “preview,” and “continue” are offered. “Back” takes the user back to “MotifView” or “OwnMotifView,” depending on whether he is using his own motif or a standard motif.

“Preview” offers the user the optional capability of seeing a preview PDF. This is opened in a separate window (TextPeview). “Continue” stores the data of the user and sends it to SendPostcard, which creates the UserJob.

With “preview” and “continue”, the user entries are preferably first pre-checked on the client side with JavaScript. The checking is carried out like with the HTML editor.

The typefaces and colors offered are preferably configurable. If the user does not select a typeface or color, then it has proven to be advantageous to utilize a default setting. If the card text entered does not fit into the surface area intended for it, then advantageously a warning is generated, but the PDF is produced. Text that does not fit any more is cut off.

The page “TextPreview” is loaded by the “preview” button on EditJava and EditHTML. TextPreview is opened as a separate window that only contains the generated preview PDF of the text page and no layout. The user can use the browser functionalities to store or print the PDF and can then close the window again.

If the user has generated his card via EditHTML or EditJava, the order data is sent to SendPostcard. SendPostcard is a page that is not visible to the user. The page accepts data, checks the address data and the acceptance of the General Terms and Conditions in addition to the client-side checking that has already been carried out (according to the same criteria) and subsequently creates the UserJob and ascertains the price for the postcard. Once this checking has been successful, SendPostcard carries out a redirect to an invoicing component 91 by means of which the payment will be transacted. This invoicing component will be referred to below as the billing server.

The billing server 91 is responsible for transacting the payment of orders. The billing server can hold modules for an unlimited number of payment systems. Even though the billing server is depicted in FIG. 3 as a separate component, it is preferably not operated in the form of a separate application or instance but rather, it is an integral part of the front end and will also be regarded as a part of the front end below.

The billing server determines which payment methods are available for an order and offers them to the user for an interactive payment procedure. For example, micro-payment systems such as T-Pay, FirstGate, etc. can be used.

The billing server is preferably expanded in such a way that the payment procedure for sponsored UserJobs is always executed automatically without being initiated by the user. For example, sponsored jobs can be paid for by bank account withdrawal, which presupposes that the user has an active bank account. If a payment procedure via a user or a sponsor is confirmed, then the user is automatically redirected to a confirmation page (SendConfirmation).

Regardless of how the order for a postcard to be printed and sent was generated, the interface 30 transfers the data for this order to an editing component 70. In an especially preferred embodiment of the invention, the editing component includes two so-called back-end services that generate the PDF files that are preferably needed for the subsequent printing production component 50 as well as the preview files. A back-end service for the image motif generation component 71 generates preview and printing data for the image motif. Another component for generating the text layouts 72 generates a printing and preview PDF of the text page. The printing files are preferably generated as PDF files in a special postcard format that has, for example, an additional edge so as to avoid a white edge or the overlapping with other motifs on the resultant mail.

The editing and conversion of data for the production of a postcard will be described below by way of an example. Here, it has proven to be advantageous that the text for a postcard to be produced can be submitted in three formats: plain text, RTF (Rich Text Format) and XML (Extensible Markup Language).

The XML format corresponds to the printing instructions as they are preferably processed on the part of the card production component. This allows one-lined text blocks, lines and images to be positioned with millimeter precision. That is why conversion to the XML format is preferable.

The plain text format is thus converted into an XML format in the editing component 70 so that an appertaining layout-production core only has to be able to process the XML format. The RTF format is likewise converted into XML by means of a module.

The plain text format corresponds to normal, unformatted text and is supplied by the front end when the user has entered the text into an HTML component. In this context, the typeface and size of the entire text on the card can be transferred by the front-end. It is preferred here for the text that has been entered via a website or a mobile terminal to be positioned line-by-line by the back-end services of the editing component. If a text line is wider than the text area of a postcard, then a line break is inserted at a suitable space.

Preferably, the JPG format is supported for the image motif of a postcard. If the JPG image contains information about its resolution (in dpi), it is advantageous to use this information in order to determine the actual size of the image (in mm). If no information about the resolution is present, then advantageously a standard resolution is assumed. The standard resolution can be, for example, 96 dpi.

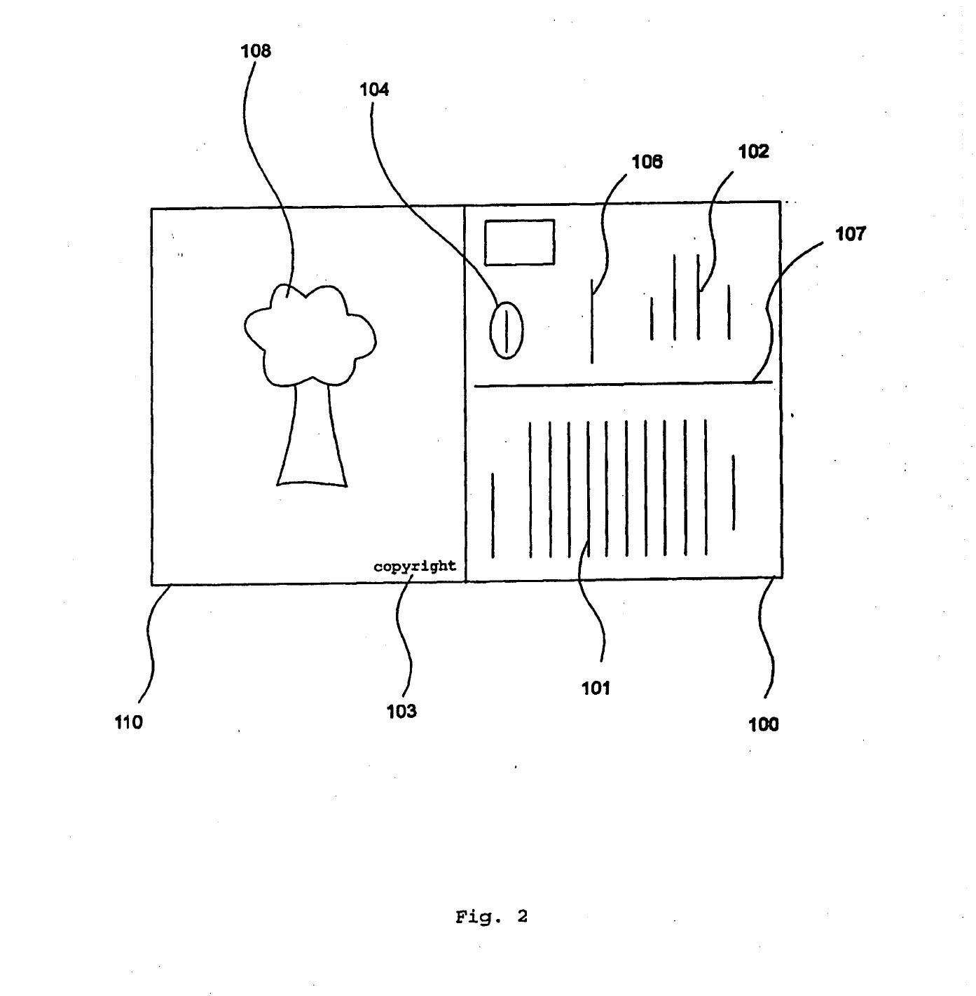

The documents to be printed consist of a production text page 100 and a production image motif page 110, as shown positioned next to each other in FIG. 2. The documents are preferably generated as one-page PDF files in a special postcard format that has an additional edge so as to avoid a white edge or the overlapping with other motifs on the resultant postcard.

The production text page 100 can contain, for example, elements such as the card text 101, delivery information (recipient address) 102, information on the copyright 103, a company logo 104, a postage indicium or a postage stamp 105, a prepaid postage marking 106 and/or a graphic element in the form of a vertical line 107 for dividing the postcard into two sections. The layout of this page can be predefined, whereby certain parameters such as margins and distances can advantageously be configured. If the user wants to upload, for example, his own logo file, this can be done via an appropriate link.

In an especially preferred embodiment of the invention, the back-end services generate a production PDF file and optionally a preview PDF file. The production PDF file contains a page that is preferably larger than a normal postcard on which the given text is positioned.

In addition to the production PDF file, two different preview PDF files can be generated:

a PDF file with a page (DIN A6) in which the text PDF file is placed over a static PDF file in order to give the customer an impression of the postcard that is being generated.

a PDF file on a page that is somewhat larger than DIN A5, on which the two sides of the postcard (image and text) are arranged below each other.

Typefaces that are not standard typefaces in the PDF format and that are available in the TrueType format are embedded in the PDF file and can thus be made available to the printer.

If the user of the system uploads his own image motif, then a PDF file is generated containing the image motif that was uploaded by the customer and that is positioned according to certain rules. If an image is not uploaded in a certain color model, it can be converted into the requisite color model. Since the CMYK color model is preferred for the printing of postcards, an image uploaded in an RGB color model is converted into the CMYK color model for the production PDF. For the generated preview image (JPG), the RGB color model can be retained or else the image can be converted into the RGB color model if CMYK was uploaded.

The back-end services analyze the image uploaded by the user and generate a PDF file on this basis for the production and a JPG image for the preview in the front end. The scaling/positioning is not carried out by the back-end service but rather, it is integrated into the PDF file with the appropriate parameters (width, height, position). Hence, the image can be optimally computed by a RIP (Raster Image Processor). The image for the production is converted into the CMYK color model before its placement into the PDF file, in order to thus achieve an optimal printing result.

In addition to the high resolution image in the PDF page, a JPG image having defined dimensions is generated for purposes of preview in the front end. This image has a white background and its layout matches the generated PDF file.

The editing component 70 transfers the printing orders generated by the back-end services to a printing production component 50 that carries out the printing orders. This printing production component is preferably configured in such a way that it can generate different postal products. Thus, for example, it can print postcards or letters. In order to be able to generate all kinds of postal products with the greatest flexibility possible, it can be advantageous here to connect various printing production components to the system 10 and/or to integrate them into the system. Thus, a given printing production component can, for instance, generate a specific postal product. When it comes to the printing production components, these can be the system's own components or else connected printing service providers that accept printing orders and, after executing them, transfer them to a distribution system 90.

In case the user has selected an image motif for a postcard from a given collection, these image motifs are present in a local data memory of the printer as preripped PostScript files with crop marks. The PostScript files have, for example, the format: 151.5 mm×108 mm. The crop marks are configured in such a way that the image is cropped to a format of 148.5 mm×105 mm. For production purposes, the printing production component 50 needs a reference to the local file present on the printer.

There are preripped PostScript files on the collator for all of the text pages. These files contain, for example, the sponsor logo, the postage indicium and, the vertical line in the middle. All other texts (copyright, text field, address field) are located in a PDF file that was generated by the back-end services. The SDL (Service Data Line) is an unambiguous numbering for reprints and is generated during the production.

If the user uploads his own image file in order to insert it into the image motif page, then a PDF file containing this image is needed for the production. This PDF file was generated by a back-end service. The printing production component 50 inserts crop marks during the production. The generation of the text page corresponds to the already described generation of this page when a user selects given image motifs.

The method according to the invention and the associated system for carrying out the method entail various advantages. For one thing, it allows users of the system to order the sending of individual pieces of mail, whereby the users have a great deal of freedom in designing the mail themselves. A user can choose not only from among a prescribed selection of image motifs, but he can also upload his own images. Through the preferred generation of orders via applications on a website, mail can be sent very easily and does not require any specially adapted auxiliary components on the user side. Moreover, the generation of orders via a mobile terminal such as a mobile telephone is a convenient and fast way to generate digital images and to send them, for example, as a postcard. In particular for sponsors, the described embodiments for sponsored events offer various possibilities for using the sponsored mailing of postcards as an advertising campaign. The requisite effort for a sponsor website can be chosen in increments by the sponsor.

### LIST OF REFERENCE NUMERALS

10 mailing service system
20 order component, front end
21 website mailing of service system
22 server mailing of service system
30 interface of front end
40 mailing product
50 printing production component
60 sponsor
61 website sponsor
62 server sponsor
70 editing component, back-end services
71 image motif generation component
72 text layout generation
80 mobile terminal
81 interface of mobile terminal
90 distribution system
91 invoicing component/billing server
100 text page
101 card text
102 delivery information
103 information on copyrights
104 company logo
105 postage indicium, postage stamp
106 prepaid postage marking
107 graphic elements for postcard division
108 postcard image motif
110 image motif side

1. A method for the automated ordering and performing of printing services and mailing services in a mailing service system, with which order data for mail to be printed and sent is generated on an order component, comprising the steps of:
generating order data with an order component, whereby the order data comprises at least one image motif and delivery information,
transmitting the order data to a database via an interface,
editing the order data into a printing order in an editing component that is connected to a database,
transmitting the printing order to a printing production component,
generating a piece of mail in the printing production component,
transferring the piece of mail to a distribution system, and
invoicing the printing service and the mailing service via an invoicing component.

2. The method according to claim 1, comprising
the order component generating an order for mail to be printed and sent in that a user selects at least one image motif and provides delivery information.

3. The method according to claim 1, wherein
the image motif for an order is an image generated on one of a user side and an image from a selection.

4. The method according to claim 1, wherein
the mail to be printed and sent is one of a postcard, a greeting card and a folding card.

5. The method according to claim 1, comprising
the invoicing component at least partially invoicing a user of the mailing service system for the printing service and the mailing service, whereby the order for mail to be printed and mailed is user generated.

6. The method according to claim 1, comprising
the invoicing component at least partially invoicing a user who is signed up with a mailing service system for the printing service and the mailing service, whereby the order for mail to be printed and mailed is not user generated.

7. The method according to claim 1, comprising
invoicing for the printing service and the mailing service via the invoicing component before printing and sending the mail.

8. The method according to claim 1, comprising
generating the order for mail to be printed and sent via applications of a website connected to an associated server, and transmitting the order data to the database via an interface.

9. The method according to claim 8, wherein
the website connected to the associated server is one of a website of the mailing service system and a website of a sponsor.

10. The method according to claim 8, comprising
automatically redirecting a user by an appropriate link on a website of a sponsor to applications on a website of the mailing service system, wherein the user employs these applications to generate an order for mail to be printed and sent, and the server transmits the data for an order to a database.

11. The method according to claim 10, comprising
carrying out automatic redirecting of the user from the website of the sponsor to the website of the mailing service system via a reciprocal communication process between a server of the sponsor and a server of the mailing service system.

12. The method according to claim 11, wherein
the reciprocal communication process comprises checking whether the user has accessed the website of the mailing service system via the website of the sponsor.

13. The method according to claim 12, wherein
no order can be generated if the verification reveals that the user did not access the website of the mailing service system via the website of the sponsor.

14. The method according to claim 8, comprising
generating the order for mail to be printed and sent on a website of a sponsor and an associated server transmitting the data for the order to a server of the mailing service system that transmits the data to the database.

15. The method according to claim 1, comprising
generating the order for mail to be printed and sent by a mobile terminal and transmitting data for the order to a database via an interface.

16. The method according to claim 15, comprising
transmitting the data to the interface via a second interface.

17. The method according to claim 16, comprising
converting the second interface the data into a format that can be processed by the interface.

18. (canceled)

19. A system for the automated ordering and performing of printing services and mailing services, with which an order for mail to be printed and sent can be generated on an order component by a user, comprising
an order component for generating order data, whereby the order data comprises at least one image motif and delivery information,
an interface to transmit the order data from an order component to a database,
an editing component connected to the database for producing printing orders from the order data,
a printing production component connected to the database for generating the mail,
an invoicing component connected to the database for purposes of invoicing for the printing service and the mailing service.

20. The system according to claim 19, wherein
the order component of comprises a website and an associated server.

21. The system according to claim 20, wherein
the order component comprises a mobile terminal.

22. The system according to claim 19, wherein
the interfaces is an http interface.

23. The system according to claim 21, wherein
in order to transmit data for an order between a mobile terminal and the interface, a second interface is located in-between, whereby the second interface is configured in such a way that it converts data received from the mobile terminal into a format that is processed by the interface.
